(19) United States
(12) Patent Application Publication
(10) Pub. No.: US 2020/0013371 A1
(43) Pub. Date: Jan. 9, 2020

(54) METHOD, CONTROLLER, AND SYSTEM FOR ADJUSTING SCREEN THROUGH INFERENCE OF IMAGE QUALITY OR SCREEN CONTENT ON DISPLAY

(71) Applicant: LG Electronics Inc., Seoul (KR)

(72) Inventors: Jin Seok YANG, Seoul (KR); Min Jae KIM, Seoul (KR)

(21) Appl. No.: 16/573,487

(22) Filed: Sep. 17, 2019

(30) Foreign Application Priority Data
Aug. 8, 2019 (KR) 10-2019-0096830

(51) Int. Cl. G09G 5/02; G06T 7/00; G06K 9/62; G06N 3/08; G06N 3/04

(52) U.S. Cl. CPC G09G 5/02; G06T 7/0002; G06K 9/627; G06N 3/08; G06N 3/04; G09G 2370/04; G06T 2207/20081; G06T 2207/20084; G09G 2320/0666; G09G 2370/022; G06T 2207/30168

(57) ABSTRACT

A screen adjusting system includes a data collector for collecting data related to a full screen generated by resizing the full screen or cropping a portion of the full screen on the display, a screen classifier for applying the collected data to a learned AI model for classifying the image quality or the genre of the full screen, or whether the full screen is a text/an image, a screen adjuster for adjusting the screen of the display based on the image quality of the full screen, the genre of the content of the full screen, or whether the full screen is a text/an image, which have been classified, and a communicator for communicating with the server. According to the present disclosure, it is possible to control the display by using the AI, the AI based screen recognition technology, and the 5G network without manually adjusting the display screen.

### CROSS-REFERENCE TO RELATED APPLICATION

This present application claims benefit of priority to Korean Patent Application No. 10-2019-0096830, entitled “METHOD, CONTROLLER, AND SYSTEM FOR ADJUSTING SCREEN THROUGH INFERENCE OF IMAGE QUALITY OR SCREEN CONTENT ON DISPLAY,” filed on Aug. 8, 2019, in the Korean Intellectual Property Office, the entire disclosure of which is incorporated herein by reference.

### BACKGROUND

### 1. Technical Field

The present disclosure relates to a display control method and a display control apparatus using gaze tracking, and more particularly, to a method, a controller, and a system for adjusting a display screen using an artificial intelligence based screen image quality or screen content inference method.

### 2. Description of Related Art

In general, an image display apparatus provided in a conventional display allows the user to manually adjust the image setting, which has been set by default when shipped from a factory, such as backlight, contrast, brightness, sharpness, color density, color, color temperature, and noise removal.

FIG. 1A is an exemplary diagram showing a passive image quality improving function provided from a conventional smartphone. As in FIG. 1A, a smartphone user may manually set a screen optimization mode by selecting a display and selecting a screen mode in the setting.

FIG. 1B is an exemplary diagram of a passive reader mode provided from a conventional notebook monitor. As in FIG. 1B, a notebook user may manually turn on a reader mode when reading a text to adjust the color temperature of the screen suitable for reading the text.

Conventionally, the user manually set a playback method or an image quality setting according to the image quality and type of the display screen being played. Regardless of the characteristics or mode of the content of the screen on the display, a display apparatus operates according to the display default setting or the image setting finally adjusted by the user, such that there is a limitation in expressing the quality of the content produced according to movies, sports, games, news reading, etc.

Conventionally, the reader mode (color temperature enhancement) for protecting the user's eyes should be manually, directly set by the user. In addition, there has been a technology for finding whether an image on the screen of the display includes a text, but there has been no technology for distinguishing whether the corresponding screen itself is an image or a text.

As an example of a display apparatus and a method for setting the image quality in the related art, disclosed is a technology for storing an image quality setting value corresponding to a plurality of image display modes related to the image quality of an image signal, displaying a menu for selecting the image display mode when a game function is selected, and adjusting the image quality of the image signal according to the image quality setting value corresponding to the selected image display mode when any one in the image display mode is selected, but this is to adjust the image quality of the image signal when the user selects any one in the image display mode, and there is a limitation that requires the user's involvement in the image setting for optimizing the screen.

As another example in the related art, an apparatus for controlling an image display apparatus of a slot machine apparatus may control the function or the image setting of the image display apparatus according to a mapping database set to a current mode analyzed by a controller when the characteristics or the mode of the image content is analyzed, thereby optimizing the image quality of the image content, optimize the image quality of the image display apparatus according to the image content, and then transmit the image content. Although the apparatus for controlling the image display apparatus of the slot machine apparatus has allowed the screen to be controlled by adjusting the image setting related to the image quality of the image display apparatus in response to the characteristics or the modes of the image content output from the slot machine apparatus, since the image setting data for optimizing the function of the image display apparatus should be stored in advance in response to the characteristics or the mode of a predetermined image content, there has been a limitation that may not optimize the display screen unless it is a predetermined image.

### SUMMARY OF THE DISCLOSURE

An object of an embodiment of the present disclosure is to infer the content and the image quality of a display screen by using an AI technology, and change a screen with the setting of an adjustment screen.

Another object of an embodiment of the present disclosure is to adjust and activate a screen in a reader mode that reduces eye fatigue of a user.

Still another object of an embodiment of the present disclosure is to infer the genre of the image played on the screen of the display to adjust and optimize a screen with the screen setting according to the genre.

Yet another object of an embodiment of the present disclosure is to provide an optimized quality to a user in the 5G era in which various contents will be consumed.

The present disclosure is not limited to what has been described above, and other aspects and advantages of the present disclosure will be understood by the following description and become apparent from the embodiments of the present disclosure. Furthermore, it will be understood that aspects and advantages of the present disclosure may be achieved by the means set forth in claims and combinations thereof.

A method and an apparatus for adjusting a screen according to an embodiment of the present disclosure for achieving the objects may be performed by inferring the image quality of the screen or the content of the screen on a display.

Specifically, the method for adjusting the screen includes collecting data related a full screen generated by resizing the full screen or cropping a portion of the full screen on the display, applying the collected data to a learned AI model for classifying the image quality of the full screen, the genre of the content of the full screen, or whether the full screen is a text/an image, outputting the image quality of the full screen, the genre of the content of the full screen, or whether the full screen is a text/an image classified from the learned AI model, and adjusting the screen of the display based on the image quality of the full screen, the genre of the content of the full size, or whether the full screen is a text/an image, which have been output, and whether the full screen is a text/an image may be related to whether the full screen is a text or an image.

In an embodiment of the present disclosure, a screen adjusting apparatus for adjusting a screen through inference of the image quality of the screen or the content of the screen on a display may include a data collector for collecting data related to a full screen generated by resizing the full screen or cropping a portion of the full screen on the display, a screen classifier for applying the collected data to a learned AI model for classifying the image quality or the genre of the full screen, or whether the full screen is a text/an image, and a screen adjuster for adjusting the screen of the display based on the image quality of the full screen, the genre of the content of the full screen, or whether the full screen is a text/an image, which have been classified.

In another embodiment of the present disclosure, in a screen adjusting system including a screen adjusting controller for adjusting the screen through inference of the image quality of the screen or the content of the screen on the display and a server, the screen adjusting controller may include a data collector for collecting data related to a full screen generated by resizing the full screen or cropping a portion of the full screen on the display, a screen classifier for applying the collected data to a learned AI model for classifying the image quality or the genre of the full screen, or whether the full screen is a text/an image, a screen adjuster for adjusting the screen of the display based on the image quality of the full screen, the genre of the content of the full screen, or whether the full screen is a text/an image, which have been classified, and a communicator for communicating with the server, the communicator transmitting the image quality of the full screen or the content of the screen on the display collected from the data collector to the server, and the server may include an AI model learner for generating a learned AI model having learned the image quality of the full screen or the content of the screen, which has been received through a deep neural network, the server may be configured to transmit the learned AI model having learned through the AI model learner to the screen adjusting controller, and the screen classifier of the screen adjusting controller may be configured to classify the image quality of the full screen, the genre of the content of the full screen, or whether the full screen is a text or an image on the display through the learned AI model received from the server.

In another embodiment of the present disclosure, the learned AI model may include one or more among an image quality classifying engine learned to infer the image quality of the full screen by using images having cropped a specific portion having the maximum edge of the full screen and specific resolution results labeled to the cropped images as learning data, a genre classifying engine learned to infer the genre of the content of the full screen by using image having resized the full screen to a specific size and genre classified results having labeled the resized images by genre of the content of the screen as the learning data, and a text/image classifying engine learned to infer whether the full screen is a text/an image by using area images having cropped the full screen into a plurality of areas and text/image results having labeled the area images with a text or an image as the learning data.

In another embodiment of the present disclosure, the text/image classifying engine may be learned to classify the area images generated by cropping the full screen into a plurality of areas in proportion to a resolution into a text or an image through Convolution Neural Network (CNN).

In another embodiment of the present disclosure, the text/image classifying engine may classify the area images into four classes of an image, an image prefer, a text prefer, and a text through the Convolution Neural Network (CNN), and determine whether the full screen is a text/an image according to whether a final value summed by multiplying the four classes for the area images by a weight is positive or negative.

In another embodiment of the present disclosure, the adjusting the screen of the display according to a predetermined setting based on the image quality, the genre, or whether the screen is a text/an image, which has been classified, or the screen adjusting controller turns on a reader mode for changing a color temperature to be suitable for reading a document when the full screen is a text screen, and turns off the reader mode when the full screen is an image screen or a partial area of the full screen is not a text screen.

In another embodiment of the present disclosure, the image quality classifying engine may be learned by confirming a specific portion having the maximum edge from the cropped images and utilizing a Data Augmentation method.

In another embodiment of the present disclosure, the image quality classifying engine may be learned by scaling-up the cropped images to Full High Definition (FHD) by using Bilinear Interpolation, and labeling the image quality of the cropped images as high, medium, low based on the characteristics in which the edge density increase at higher resolution.

In another embodiment of the present disclosure, the outputting the image quality of the full screen, the genre of the content of the full screen, or whether the full screen is a text/an image or the screen classifier may include classifying the image quality of the full screen into high, medium, low according to a resolution through the image quality classifying engine.

In another embodiment of the present disclosure, the adjusting the screen of the display may be executed by collecting results having repeated the collecting the data related to the full screen, the applying to the learned AI model, and the outputting the image quality of the full screen, the genre of the content of the full screen, or whether the full screen is a text/an image at a specific time interval

In another embodiment of the present disclosure, the screen adjuster may adjust one or more among backlight adjustment, stereoscopic, sharpness, edge sharpness, image noise removal, brightness, contrast, gamma, overdrive, color temperature, color depth, resolution, and color by a predetermined setting for the image quality of the full screen, the genre of the content of the full screen, or whether the full screen is a text/an image, which has been classified.

In addition, other methods, other systems, and a computer program for executing the method for implementing the present disclosure may be further provided.

Other aspects, features, and advantages other than those described above will become apparent from the following drawings, claims, and detailed description of the disclosure.

According to an embodiment of the present disclosure, it is possible to control the display by using the artificial intelligence (AI), the artificial intelligence based screen recognition technology, and the 5G network without manually adjusting the display screen.

It is possible to recognize the image quality of the screen on the display to adjust the screen with the setting of the adjusted screen, thereby providing the optimal playback mode to the user.

In addition, it is possible to automatically set the reader mode when the user uses the text based screen for a long time, thereby reducing eye fatigue of the user.

In addition, it is possible to infer the genre of the content of the screen to be played to adjust the screen in the adjustment playback mode, thereby providing the optimal playback mode according to the playback content.

The effects of the present disclosure are not limited to those mentioned above, and other effects not mentioned may be clearly understood by those skilled in the art from the following description.

### BRIEF DESCRIPTION OF THE DRAWINGS

FIG. 1A is an exemplary diagram showing a manual image quality improving function provided from a conventional smartphone.

FIG. 1B is an exemplary diagram of a manual reader mode provided from a conventional notebook monitor.

FIG. 2 is an exemplary diagram of a system environment including a user display apparatus including a display screen adjusting controller, a server, and a network for communicatively connecting them according to an embodiment of the present disclosure.

FIG. 3 is an exemplary diagram of a screen adjusting apparatus according to an embodiment of the present disclosure.

FIG. 4A is a block diagram of the screen adjusting controller according to an embodiment of the present disclosure.

FIG. 4B is a flowchart showing the function of the screen adjusting controller according to an embodiment of the present disclosure.

FIG. 5A is a detailed flowchart of the method for adjusting the screen by inferring the image quality of the screen or the content of the screen on a display according to an embodiment of the present disclosure.

FIG. 5B is a flowchart for learning an AI model for inferring the image quality of the screen or the content of the screen of FIG. 5A.

FIG. 6A is an exemplary table labeling a text/an image as four classes in order to learn a text/image classifying engine to be used in a screen classifier through an artificial intelligence mode learner according to an embodiment of the present disclosure.

FIG. 6B is an exemplary table for explaining a method for learning the text/image classifying engine according to an embodiment of the present disclosure through the AI model learner according to an embodiment of the present disclosure.

FIG. 6C is a flowchart showing a functional operation for inferring whether the screen is a text/an image and adjusting the screen in the screen adjusting controller by using the text/image classifying engine learned through the AI model learner according to an embodiment of the present disclosure.

FIG. 6D is an exemplary diagram showing a functional operation of the text/image classifying engine in the screen adjusting controller according to an embodiment of the present disclosure of FIG. 6C.

FIG. 7A is a flowchart learning an image quality classifying engine through the AI model learner according to an embodiment of the present disclosure.

FIG. 7B is an exemplary diagram of learning data labeling images according to the resolution of the images in order to learn the image quality classifying engine through the AI model learner according to an embodiment of the present disclosure.

FIG. 8A is an exemplary diagram of a process of learning an genre classifying engine through the AI model learner according to an embodiment of the present disclosure.

FIG. 8B is an exemplary diagram of a method for collecting data for learning the genre classifying engine through the AI model learner according to an embodiment of the present disclosure.

FIG. 9 is a flowchart showing a functional operation of inferring the image quality of the screen or the genre, and adjusting the screen in the screen adjusting controller through the image quality classifying engine and the genre classifying engine learned in the AI model learner according to an embodiment of the present disclosure.

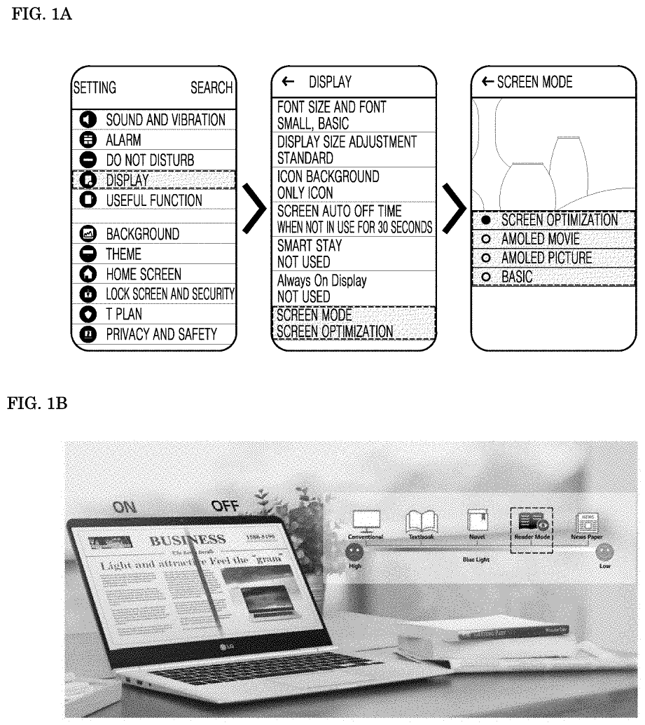

### DETAILED DESCRIPTION

Advantages and features of the present disclosure and methods for achieving them will become apparent from the descriptions of aspects hereinbelow with reference to the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification in so much as such details are not necessary to obtain a complete understanding of the present disclosure.

The terminology used herein is used for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of conditioned features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, embodiments of the present disclosure will be described in detail with reference to the accompanying drawings. Like reference numerals designate like elements throughout the specification, and overlapping descriptions of the elements will not be provided.

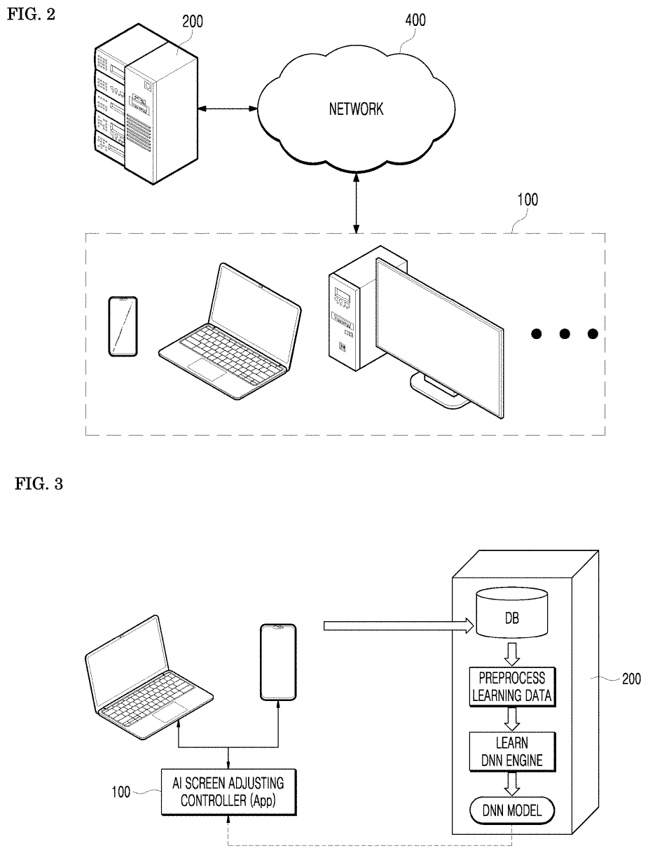

FIG. 2 is an exemplary diagram of a system environment including a user display apparatus including a display screen adjusting controller, a server, and a network for communicatively connecting them according to an embodiment of the present disclosure.

Referring to FIG. 2, a screen adjusting controller 100, which is a screen adjusting apparatus included in various types of user display apparatuses, and a server 200 are communicatively connected to each other through a network 400. The user display apparatus may be a notebook, a desktop computer, a TV, etc. The user display apparatus may be a terminal for performing at least one of wired communication and wireless communication. Various embodiments of the wireless terminal may include not only a cellular telephone, a smart phone with a wireless communication function, a personal digital assistant (PDA) with a wireless communication function, a wireless modem, a portable computer with a wireless communication function, a photographing device such as a digital camera with a wireless communication function, a gaming device with a wireless communication function, a music storage and playback appliance with a wireless communication function, and an internet appliance in which wireless internet access and browsing are possible, but also portable units or terminals integrating combinations of these functions, but are not limited thereto.

The screen adjusting controller 100 installed in the user display apparatus may use the server 200 for the purpose of learning an AI model that infers (or estimates) the image quality of the full screen, the genre of the content of the full screen, or whether the screen is a text/an image on a display 105. For example, although the screen adjusting controller 100 may include an AI model learner 101 to use by directly generating the learned AI model by itself for classifying the image quality of the full screen, the genre of the content of the full screen, or whether the screen is a text/an image, the server 200 may include the AI model learner 101, and may also use big data type of data collected by the server 200 instead.

The screen adjusting controller 100 may use various programs related to an AI algorithm stored in a local area or stored in the server 200. That is, the server 200 may serve as learning an AI model by using the data collected together with data collection. The screen adjusting controller 100 may control to adjust the screen of the display 105 by using the image quality of the screen, the genre, or the classification as to whether the screen is a text/an image of the screen based on the generated AI model.

The server 200 may provide the user terminal with the training data necessary for recognizing the image quality of the screen, or the content of the screen by an AI algorithm and various programs related to the AI algorithm, for example, an API, a workflow, etc. That is, the server 200 may learn the AI model by using the training data including a screen for classifying the image quality of the full screen, the genre of the content of the full screen, or whether the screen is a text/an image. In addition, the server 200 may evaluate the AI model, and even after the evaluation, may update the AI model for better performance. Here, the screen adjusting controller 100 may perform a series of operations performed by the server 200 alone or together with the server 200.

The network 400 may be any suitable communication network including a wired and wireless network, for example, a local area network (LAN), a wide area network (WAN), an internet, an intranet, an extranet, and a mobile network, for example, cellular, 3G, LTE, 5G, WiFi networks, an ad hoc network, and a combination thereof.

The network 400 may include a connection of network elements such as a hub, a bridge, a router, a switch, and a gateway. The network 400 may include one or more connected networks, including a public network such as the Internet and a private network such as a secure corporate private network.

For example, the network may include a multi-network environment. The access to the network 400 may be provided via one or more wired or wireless access networks.

Hereinafter, a screen adjusting system and the screen adjusting controller 100 according to an embodiment of the present disclosure will be described in detail.

FIG. 3 is an exemplary diagram of a screen adjusting system according to an embodiment of the present disclosure.

The screen adjusting system may include the screen adjusting controller 100 for adjusting the screen by inferring the image quality of the screen or the content of the screen on the display 105 and the server 200. The screen adjusting controller 100 may be executed in the form of a program or an application app on a user terminal or a laptop, a desktop computer, etc., and embedded in a TV.

A communicator 103 of the screen adjusting controller 100 may transmit the image quality or the screen content of the full screen on the display 105 collected by a screen data collector to the server 200.

The server 200 may include the AI model learner 101 for generating the learned AI model that has learned the collected image quality or the screen content of the full screen through a deep neural network (DNN). The AI model learner 101 may be configured to extract training data necessary for learning through the deep neural network from a database for storing screen data necessary for machine learning or deep learning, to preprocess the training data in order to increase the accuracy of the training data, to learn through the deep neural network (DNN), and to generate the learned AI model.

Data preprocessing refers to removing or modifying learning data to maximally increase the accuracy of source data. In addition, if they contain excessively insignificant data, it also reduces and adjusts them properly to change into a form that is easy to manage and use. The data preprocessing includes data refinement, data integration, data transformation, data reduction, etc. The data refinement is to fill missing values, to smooth noisy data, to identify outliers, and to correct data inconsistency.

The server 200 may be configured to transmit the learned AI model learned through the AI model learner to the screen adjusting controller 100. A screen classifier 120 of the screen adjusting controller 100 may be configured to classify the screen quality, the genre of the content of the screen, or whether the content of the screen is a text/an image on the display 105 through the learned AI model received from the server.

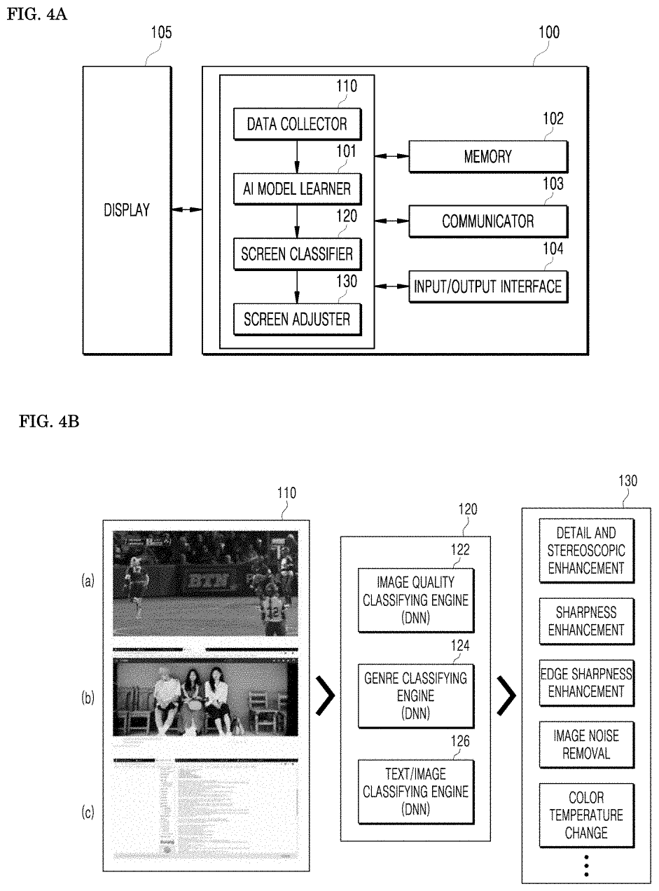

FIG. 4A is a block diagram of a screen adjusting controller according to an embodiment of the present disclosure.

The screen adjusting controller 100 may include a data collector 110 for collecting data about the full screen from a display apparatus, the AI model learner 101 for learning through the deep neural network based on the collected data, the screen classifier 120, a screen adjuster 130, memory 102 for storing various data such as image screen related data, and learning data, the communicator 103 for communicating with a server or an external device, and an input/output adjuster 104 of the screen adjusting controller.

The data collector 110 may collect data related to the full screen generated by resizing the full screen on the display 105 or cropping a portion of the full screen. The screen classifier 120 may classify the image quality of the full screen, the genre of the content of the full screen, or whether the content of the full screen is a text/an image with respect to the data collected through the learned AI learning model.

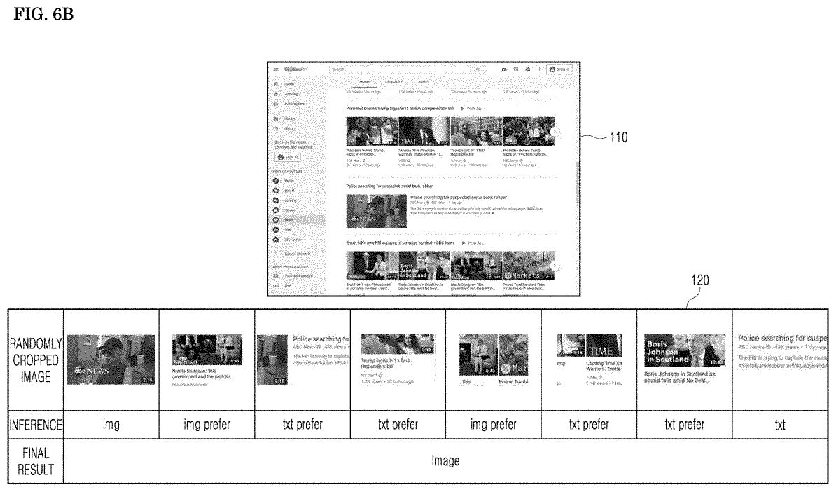

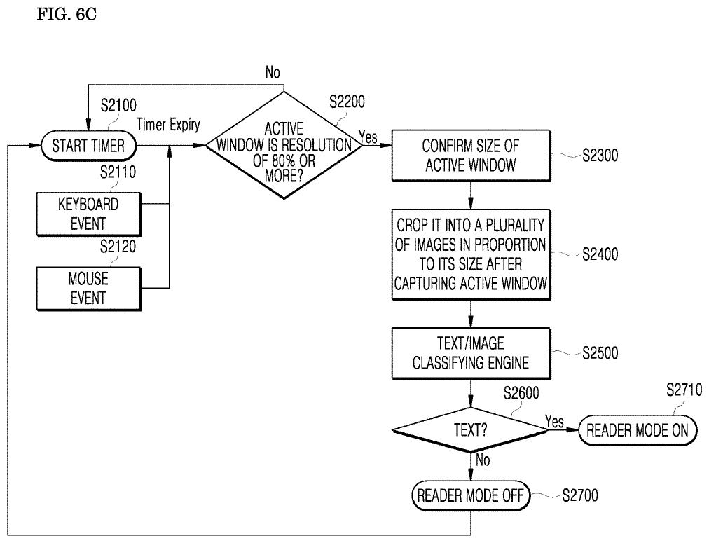

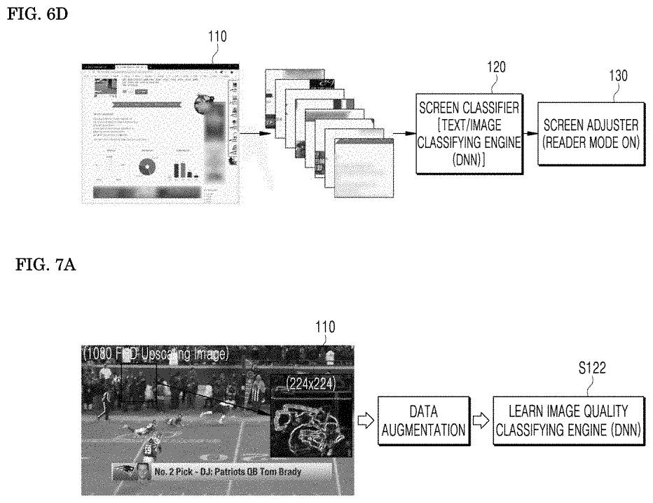

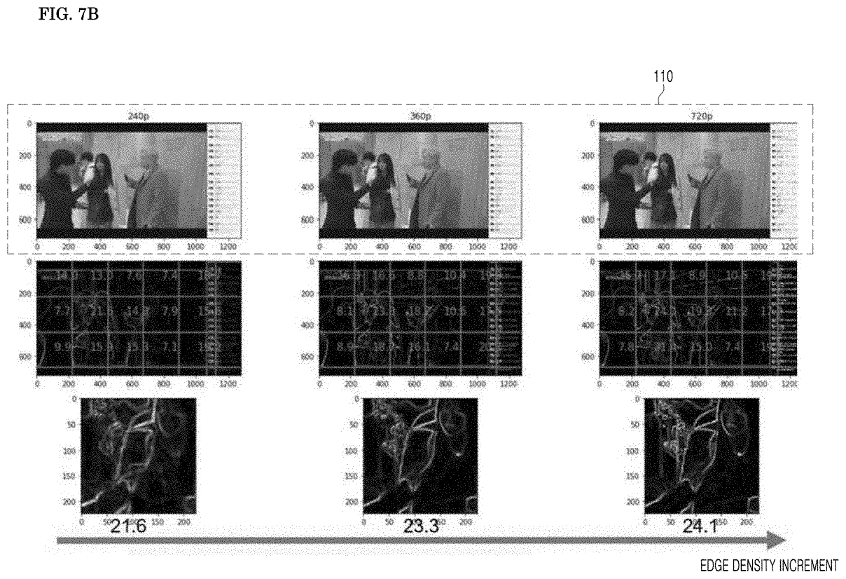

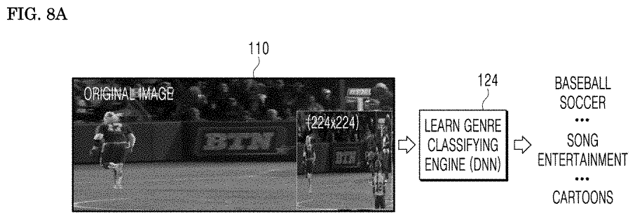

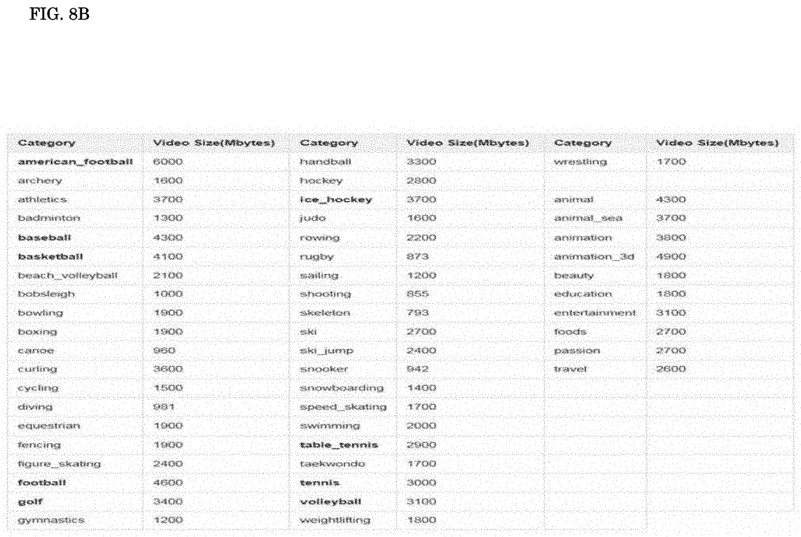

The AI model learner 101 may be configured to learn an image quality classifying engine 122 learned to infer the image quality of the full screen by using the images for cropping a specific portion having the maximum edge of the full screen and specific resolution results labeled to the cropped images as learning data (or learning data set), a genre classifying engine 124 learned to infer the genre of the content of the full screen by using images having resized the full screen to a specific size and genre classified results of labeling the resized images by genre of the content of the screen as the learning data, and a text/image classifying engine 126 learned to infer whether the full screen is a text/an image by using area images cropping the full screen into a plurality of areas and text/image results having labeled the area images to a text or an image as the learning data. The AI model learner 101 may generate an AI model by using supervised learning, but may learn the image quality classifying engine 122, the genre classifying engine 124, and the text/image classifying engine 126 by using unsupervised learning or reinforcement learning. Learning of the text/image classifying engine 126 through the deep neural network is described in FIGS. 6A and 6B, learning of the image quality classifying engine 122 is described in FIGS. 7A and 7B, and learning of the genre classifying engine 124 is described in FIGS. 8A and 8B.

The screen classifier 120 may classify the image quality of the full screen, the genre of the content of the screen or whether the screen is a text/an image with respect to the data collected from the data collector 110 through the AI model learned from the AI model learner 101. In another embodiment of the present disclosure, as described above, the screen classifier 120 may be configured to classify the image quality of the screen, the genre of the content of the screen, or whether the content of the screen is a text/an image on the display 105 through the learned AI model received from the server.

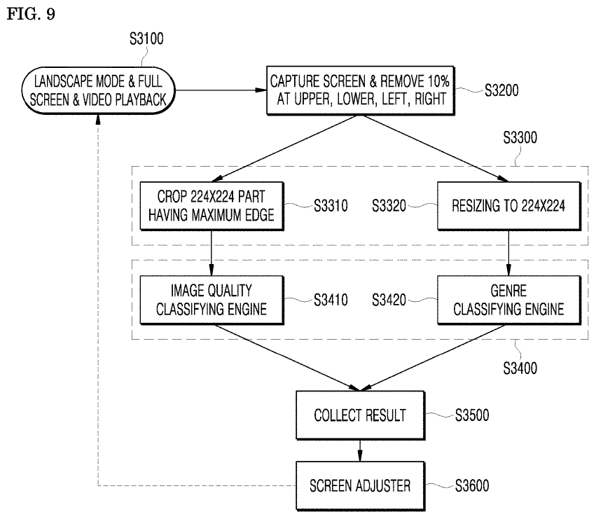

The screen adjuster 130 may optimize the screen of the display by adjusting the screen of the display according to a predetermined setting based on the image quality of the full screen, the genre, or whether the screen is a text/an image classified by the screen classifier 120. In the present disclosure, ‘screen optimization’ refers to adjusting the screen of the display to the image quality that is most suitable for watching according to the taste and purpose of the user. The screen adjuster 130 may adjust one or more among backlight adjustment, stereoscopic, sharpness, edge sharpness, image noise removal, brightness, contrast, gamma, overdrive, color temperature, color depth, resolution, and color by a predetermined setting for the image quality of the full screen (for example, high, medium, or low resolution) of the full screen, the genre of the content of the full screen (for example, movies, photos, games, etc.), or whether the full screen is a text/an image in order to optimize it into the screen that is most suitable for the user to watch on the display. For example, the screen adjuster 130 may adjust the image quality of the screen according to a known predetermined setting for a cinema mode, a sports mode, a photo viewing mode, a document reading mode (reader mode), a game mode, and a standard mode, or a predetermined setting set by a user or a manufacturer. A screen adjusting functional operation according to the result of the text/image classifying engine of the screen of the picture viewing screen adjuster 130 is described in FIGS. 6C and 6D, and a screen adjusting functional operation according to the result of the genre of the image quality of the screen and the content of the screen is described in FIG. 9.

In an embodiment of the present disclosure, the screen adjuster 130 may adjust the screen of the display by collecting data related to the full screen for a specific time from the data collector 110 and the screen classifier 120, and collecting the results of classifying the image quality of the full screen, the genre of the full screen, or whether the full screen is a text/an image classified and output by the screen classifier 120.

If the screen adjusting controller 100 is included in a user terminal, a notebook computer, or a desktop computer by a method executed in the form of a program or an app, the screen adjusting controller 100 may communicate with an external device by using the communicator 103 of the user terminal, the notebook, or the desktop computer through the input/output adjuster 104 without including the communicator 103.

FIG. 4B is a flowchart showing a function of a screen adjusting controller according to an embodiment of the present disclosure.

The screen adjusting controller 120 may collect data related to the full screen on the display 105 in the data collector 110, and infer and classify the image quality of the screen, the genre of the content of the screen, and whether the screen is a text/an image in the screen classifier 120 including the image quality classifying engine 122, the genre classifying engine 124, and the text/image classifying engine 126 learned by the AI model learner 101. The screen adjuster 130 may adjust the image setting such as stereoscopic enhancement, sharpness enhancement, edge sharpness enhancement, image noise removal, and color temperature change based on the results classified by the screen classifier 120. The image setting may adjust a Display-IC rather than a frame-by-frame filter method, and in this case, there is strength in power and performance over the frame-by-frame filter method.

When having received the sports screen data as in FIG. 4B (a), the data collector 110 may infer the image quality of the full screen (for example, resolution 360p) through the image quality classifying engine 122 of the screen classifier 120, infer it as a sports genre through the genre classifying engine 124, infer it as an image screen in the text/image classifying engine 126, and then based on the above, adjust the image setting suitable for the sports mode, for example, the image setting for clearly expressing the image a fast-moving image such as a ball kicker or a ball thrower in the screen adjusting controller 130. The specific image setting suitable for the sports mode may be based on known sports image setting information.

When having received the movie screen data as shown in FIG. 4B (b), the data collector 110 may infer the image quality of the full screen (for example, the resolution 360p) through the image quality classifying engine 122 of the screen classifier 120, infer it as a movie genre through the genre classifying engine 124, infer it as the image screen from the text/image classifying engine 126, and then, based on the above, adjust the image setting suitable for the movie viewing mode in the screen adjusting controller 130. The specific image setting suitable for the movie mode may be based on known movie image setting information.

In addition, when having received the text screen data as in FIG. 4B (c), the data collector 110 may infer the image quality of the full screen (for example, the resolution 360p) through the image quality classifying engine 122 of the screen classifier 120, infer it as a teaching learning genre through the genre classifying engine 124, infer it as a text screen from the text/image classifying engine 126, and then based on the above, adjust the image setting suitable for the text mode. The specific image setting suitable for the text mode may be based on known text image setting information.

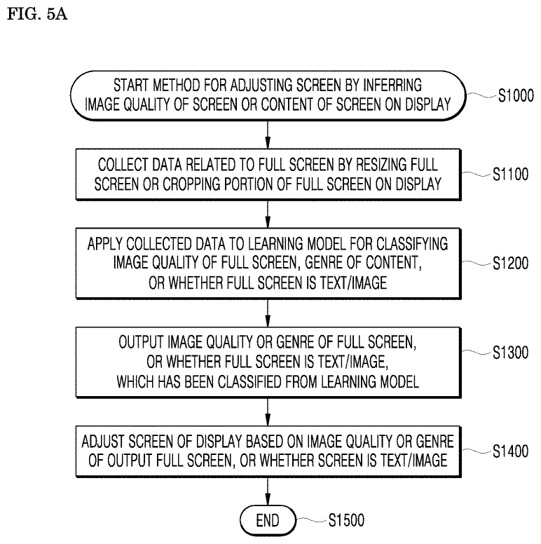

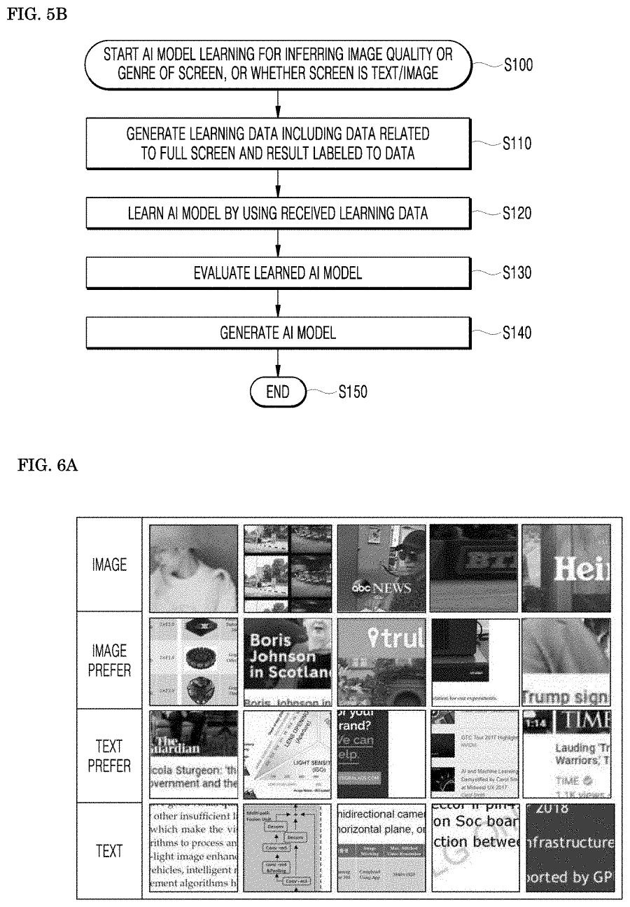

FIG. 5A is a detailed flowchart of a method for adjusting a screen by inferring the image quality of the screen or the content of the screen on the display 105.

The screen adjusting controller 100 may be turned on by a user setting, and when turned on, the screen adjusting controller 100 starts the process of adjusting a screen by inferring the image quality of the screen or the content of the screen on the display 105 (operation S1000).

The data related to the full screen is collected by resizing the full screen on the display 105 or cropping a portion of the full screen (operation S1100).

The collected data is applied to an AI (DNN) learning model for classifying the image quality of the full screen, the genre of the content, or whether the screen is a text/an image (operation S1200).

The image quality or the genre of the full screen or whether the screen is a text/an image classified from the AI learning model is output (operation S1300).

The screen of the display is adjusted according to a predetermined setting based on the output image quality or genre of the full screen, or whether the screen is a text/an image (operation S1400).

The process of adjusting the screen by inferring the image quality of the screen or the content of the screen on the display 105 is terminated (operation S1500).

In an embodiment of the disclosure, a program programmed to execute the method for adjusting the screen by inferring the image quality of the screen or the content of the screen on the display 105 may be stored in a computer-readable recording medium.

FIG. 5B is a flowchart for learning an AI model for inferring the image quality of the screen or the content of the screen of FIG. 5A.

Referring to FIG. 5B, a process of learning an AI model for inferring the image quality or the genre of the screen, or whether the screen is a text/an image on the display 105 or learning the inferring AI model may be described. The learning of the AI model for inferring the image quality or the genre of the screen, or whether the screen is a text/an image to be applied in the screen adjusting controller 100 starts (operation S100). The learning of the AI model may be performed in any one form of supervised learning, unsupervised learning, and reinforcement learning.

The data for learning the AI model including data related to the full screen that has resized the full screen on the display 105 or the full screen that has cropped a portion of the full screen and the result labeled to the data may be generated (operation S110). The data collector 110 may generate an image data value and an image quality value, a genre value, or a text/image value labeled with respect to the screen data value as the data for learning the AI model and the test data at regular intervals. A ratio of the learning data and the test data may vary according to the amount of data, and may be generally defined as a ratio of 7:3. The collecting and storing the learning data may collect and store images of video sites on the Internet by genre and image quality, and may collect an actual use screen through a capture app. The collecting and storing the learning data may collect and store videos and images in the server 200. The data for learning the AI model may be subjected to data preprocessing and data augmentation processes in order to obtain accurate learning results.

An artificial neural network, such as the AI model, for example, CNN learns the features of the image quality or the genre of the full screen, or whether the screen is a text/an image by using the learning data collected through the supervised learning (operation S120). In an embodiment of the present disclosure, a deep learning-based screen analyzer may be used, and for example, the AI learning model is tuned and used based on TensorFlow or MobileNetV1/MobileNetV2 of Keras, which is an AI language library used for AI programming.

Convolutional Neural Network (CNN) is the most representative method of the deep neural network, which characterizes images from small features to complex ones. The CNN is an artificial neural network that is composed of one or several convolutional layers and general artificial neural network layers mounted on it to perform preprocessing on the convolutional layer. For example, in order to learn the image of a human face through the CNN, the first step is to extract simple features by a filter to create a convolutional layer, and to add a new layer, for example, a pooling layer for extracting more complex feature from these features. The convolutional layer is a layer for extracting features through a convolutional operation, and performs multiplication with a regular pattern. The pooling layer reduces the dimension of the image through sub-sampling with a layer for abstracting an input space. For example, it may compress a facial image of a 28×28 size into 12×12 by creating a 24×24 feature map, respectively, by using four filters for one person and performing sub-sampling (or pooling) by a stride. In the next layer, it may create 12 feature maps in 8×8 size, perform sub-sampling by 4×4 again, and finally classify the image by learning with the neural network with the input of 12×4×4=192. Accordingly, multiple convolutional layers may be connected to extract the features of the image and finally learned by using an error back propagation neural network. The advantage of the CNN is to create a filter for characterizing the features of the image through artificial neural network learning.

An AI model is generated through evaluation of the learned AI model (operation S130) (operation S140). The evaluation of the learned AI model (operation S130) is performed by using the test data. Throughout the present disclosure, the ‘learned AI model’ means learning the learning data and determining the learned model after testing through the generated test data even without special mention. Hereinafter, the AI model for learning the image quality or the genre of the full screen, and whether the screen is a text/an image will be described.

The artificial intelligence (AI) is one field of computer science and information technology that studies methods to make computers mimic intelligent human behaviors such as reasoning, learning, self-improving and the like.

In addition, the artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed.

More specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, may take an approach that builds models for deriving predictions and decisions from inputted data.

Many Machine Learning algorithms have been developed on how to classify data in the Machine Learning. Representative examples of such machine learning algorithms for data classification include a decision tree, a Bayesian network, a support vector machine (operation SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. In addition, the Artificial Neural Network may include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

The Artificial Neural Network may include network models of the method such as Deep Neural Network (DNN), Recurrent Neural Network (RNN), Bidirectional Recurrent Deep Neural Network (BRDNN), Multilayer Perceptron (MLP), and Convolutional Neural Network (CNN), but is not limited thereto.

The terms “layer” and “hierarchy” may be used interchangeably herein.

An ANN may be classified as a single-layer neural network or a multi-layer neural network, based on the number of layers therein.

In general, a single-layer neural network may include an input layer and an output layer.

In addition, a general Multi-Layer Neural Network is composed of an Input layer, one or more Hidden layers, and an Output layer.

The Input layer is a layer that accepts external data, the number of neurons in the Input layer is equal to the number of input variables, and the Hidden layer is disposed between the Input layer and the Output layer and receives a signal from the Input layer to extract the characteristics to transfer it to the Output layer. The output layer receives a signal from the hidden layer and outputs an output value based on the received signal. The Input signal between neurons is multiplied by each connection strength (weight) and then summed, and if the sum is larger than the threshold of the neuron, the neuron is activated to output the output value obtained through the activation function.

Meanwhile, the Deep Neural Network including a plurality of Hidden layers between the Input layer and the Output layer may be a representative Artificial Neural Network that implements Deep Learning, which is a type of Machine Learning technology.

The Artificial Neural Network may be trained by using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data may classify or cluster inputted data according to a pattern within the inputted data.

Throughout the present specification, an artificial neural network trained using training data may be referred to as a trained model.

Hereinbelow, learning paradigms of an artificial neural network will be described in detail.

The learning method of the Artificial Neural Network may be largely classified into Supervised Learning, Unsupervised Learning, Semi-supervised Learning, and Reinforcement Learning.

The Supervised Learning is a method of the Machine Learning for inferring one function from the training data.

Then, among the thus inferred functions, outputting consecutive values is referred to as regression, and predicting and outputting a class of an input vector is referred to as classification.

In the Supervised Learning, the Artificial Neural Network is learned in a state where a label for the training data has been given.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels.

Using training data and labeling data together, the artificial neural network may derive a correlation function between the training data and the labeling data. Then, the parameter of the Artificial Neural Network may be determined (optimized) by evaluating the function inferred from the Artificial Neural Network.

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

The terms “layer” and “hierarchy” may be used interchangeably herein.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One of semi-supervised learning techniques involves guessing the label of unlabeled training data, and then using this guessed label for learning. This technique may be used advantageously when the cost associated with the labeling process is high.

Reinforcement learning may be based on a theory that given the condition under which a reinforcement learning agent may determine what action to choose at each time instance, the agent may find an optimal path to a solution solely based on experience without reference to data.

The Reinforcement Learning may be mainly performed by a Markov Decision Process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters may be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (operation SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters may be set to optimal values that provide a stable learning rate and accuracy.

FIG. 6A is an exemplary table in which a text/an image is labeled into four classes in order to learn a text/image classifying engine to be used in the screen classifier 120 through an AI model learner according to an embodiment of the present disclosure.

Supervised learning of the AI learning may be used to train the text/image engine 126. The text/image classifying engine 126 may be learned to classify the area images generated by cropping the full screen into a plurality of areas in proportion to the resolution into a text or an image through the Convolution Neural Network (CNN).

The AI model learner 101 may learn the text/image classifying engine 126 by inputting a plurality of images cropped from the full screen or the active window and four classes labeled to the plurality of images to the CNN, which is one of the deep neural network learning algorithms, as learning data.

The images to be labeled may be classified into four classes: an image, an image prefer, a text prefer, and a text. The image class includes a case where all of the cropped images are all images, and an image containing a few characters such as subtitles. The image prefer class is a mixture of the text and the image, but the image is mainly dominant. For example, an image having the image of a ratio of 50% or more among the cropped images may be labeled with an image prefer class. The text prefer class is a mixture of the text and the image, but the text is mainly dominant. For example, an image having a text of 50% or more among the cropped image may be labeled with the text prefer class. The text class may be determined when all cropped images are all text.

In an embodiment of the present disclosure, a neural network such as a DNN or a CNN may be learned by using text classification libraries of Keras or TensorFlow for text/image classification.

FIG. 6B is an exemplary table for explaining a method for learning a text/image classifying engine according to an embodiment of the present disclosure through the AI model learner according to an embodiment of the present disclosure. FIG. 6B shows an embodiment of inferring a text/an image with two classes in the text/image classifying engine.

In FIG. 6A, it is possible to collect the images classified into four classes and infer with two classes. The AI model learner 101 may design a deep neural network so as to infer the randomly cropped images into four classes, then collect them, and finally classify them into two classes of the text/image. For example, the AI model learner 101 may weigh the inferred results of FIG. 6B to the image (−10), the image prefer (−5), the text prefer (2), and the text (10) to sum the classified results and obtain whether the final result is an image (negative) or a text (positive). The inferred result of FIG. 6B is a case where the results classified as the text prefer have been numerically high, but the final result has been obtained as an image because the weight of the image prefer is high. That is, since the image+image prefer*2+text prefer*4+text=−10+(−5)*2+(2)*4+10=−2 has been finally negative, it has been classified as an image.

FIG. 6C is a flowchart showing a functional operation of inferring whether a screen is a text/an image and adjusting the screen in a screen adjusting controller by using a text/image classifying engine learned through an AI model learner according to an embodiment of the present disclosure.

In operation S2100, an inference is performed at a specific time interval, for example, every 5 seconds by starting a timer. If a keyboard or mouse input occurs, the inference operation may be performed after resetting a timer until the keyboard event operation (Up/Down/Page Up/Page Down/Home/End) (operation S2110) or the mouse event operation (Wheel Up or Down/Click) (operation S2120) is terminated. When 5 seconds have expired, it is determined whether the full screen or the active window is 80% of the resolution (operation S2200), and when it is not 80%, the 5 second inference is performed, and when it is 80% or more, the size of the full screen or the active window is confirmed (operation S2300). The image is cropped into a plurality of images in proportion to its size after capturing the full screen or the active window (operation S2400). For example, the image is cropped into 12 images with 1920×1040 resolution. Whether the screen is a text/an image is classified through the text/image classifying engine, which is a learned AI model (operation S2500). If it is an image by summing the classified results (operation S2600), the reader mode is turned off (operation S2700) and it returns to the beginning at which the timer starts in order to monitor whether the screen is a text (operation S2100), and if it is a text, the reader mode is turned on in operation S2710. When the classified results are summed, whether it is each text or image may be weighted and summed. For example, the classified result may be summed by weighting the image (−10), the image prefer (−5), the text prefer (2), and the text (10).

FIG. 6D is an exemplary diagram showing a functional operation of a text/image classifying engine in the screen adjusting controller according to an embodiment of the present disclosure of FIG. 6C.

First, the data collector 110 may generate images by capturing the full screen or the activated window on the display 105 to crop several areas in proportion to a resolution (operation S2400). Thereafter, it may be determined whether it is a text or an image by putting the generated image into the text/image classifying engine (Convolution Neural Network) of the screen classifier 120 (operation S2500). The type of contents currently viewed may be determined as a text by summing the result from the text/image classifier (operation S2600). The reader mode is turned on by transferring the summed result to the screen adjuster 130 of the screen adjusting controller 100 (operation S2710) or the reader mode may be turned off (operation S2700). The screen adjuster 130 turns on the reader mode for changing the color temperature to be suitable for reading a document when the full screen is a text screen, and when the full screen is an image screen or when a partial area of the full screen is a non-text screen, the reader mode may be turned off.

The text/image classifying engine 120 may change a functional operation method according to the usage pattern of the user. For example, when the screen changes rapidly (at the time of mouse scroll), it may be operated when the mouse scroll is stopped without operating the screen adjusting controller. In addition, when mainly performing keyboard input, the screen adjusting controller may be periodically operated.

The screen adjuster 130 may adjust the screen image setting so as to turn on the reader mode when the full screen is classified as a text based on the text/image classified result of the text/image classifying engine 120.

FIG. 7A is a flow diagram for learning an image quality classifying engine through the AI model learner according to an embodiment of the present disclosure.

In an embodiment of the present disclosure, in order to learn the image quality classifying engine 122 of the screen classifier 120, the original image may be resized to a size of FHD (2340×1080), and bilinear interpolation may be used. In addition, the edge of the screen may be confirmed by using a Sobel Edge technique, and the 230×230 part having the maximum edge of the full screen may be confirmed by a sliding window method.

In an embodiment, the image quality classifying engine 122 may learn a specific portion having the maximum edge from the cropped images and may be learned by utilizing a data augmentation method. In order to learn the image quality classifying engine 122, one or more of the data preprocessing and data augmentation methods may be used, and may learn through MobileNetv1 of Keras or TensorFlow by using the 224×224 part as an input. The resolution of the cropped images may be labeled with 144p, 240p, 360p, 480p, 720p, 1080p, etc. to generate learning data.

The data augmentation may be used in the learning operation and the testing operation of the AI model, and the data augmentation is to increase the number of images through a change such as rotating the image or flipping from side to side. For example, the data augmentation may set to perform data augmentation in a next batch function of TensorFlow, and return patch-level images.

FIG. 7B is an exemplary diagram of learning data for labeling images according to the resolution of images in order to learn the image quality classifying engine through the AI model learner according to an embodiment of the present disclosure.

Since the image is scaled up to FHD and output to the screen by using the bilinear interpolation of a smartphone, the characteristics in which the edge becomes sharper at higher resolution may be used. In FIG. 7B, as in a case where the resolution edge is 21.6 at 240p, the resolution edge is 23.3 at 360p, and the resolution edge is 24.1 at 720p, it may be seen that the edge density increases as the resolution increases at different resolutions.

Accordingly, the cropped images are scaled up to Full High Definition (FHD) by using bilinear interpolation, and the image quality of the cropped images may be labeled with high, medium, and low based on the characteristics in which the edge density increases at higher resolutions to learn the image quality classifying engine 122.

FIG. 8A is an exemplary diagram of a process of learning a genre classifying engine through the AI model learner according to an embodiment of the present disclosure.

The AI model learner 101 may resize the original image to a size of 224×224 by using bilinear interpolation in order to learn the genre classifying engine. Thereinafter, the genre may be learned by using MobileNetv1, which is a library of Keras or TensorFlow, by using the 224×224 as an input.

FIG. 8B is an exemplary diagram of a method for collecting data for learning the genre classifying engine through the AI model learner according to an embodiment of the present disclosure.

In the table of FIG. 8B, data of 41 items related to sports, 2 items related to animation, and 8 items related to a general image were collected. Each screen may be labeled with 51 genres such as sports, animation, entertainment, news, cartoons, and movies to learn the resized images. The genre may be learned by classifying it into detailed genres. For example, sports may be learned by sub-dividing into baseball, soccer, boxing, etc. for each sport.

FIG. 9 is a diagram showing a functional operation of inferring the image quality or genre of the screen in the screen adjusting controller through the image quality classifying engine and the genre classifying engine learned by the AI model learner according to an embodiment of the present disclosure.

The screen adjusting controller 100 senses whether the screen on the display 105 is in the landscape mode and the video is being played in the full screen and starts the screen adjustment process (operation S3100). Thereafter, the screen adjusting controller 100 may screen-remove an accurate 10% at up, down, left, and right by the data preprocessing in order to capture the screen and obtain the classifying value (operation S3200). Thereafter, the captured screen is cropped or resized (operation S3300), input to the screen classifier 120 to obtain an output (operation S3400), and the output results are collected (operation S3500). In order to classify the image quality of the screen, the 224×224 part having the maximum edge in the captured screen is cropped (operation S3310), and input to the image quality classifying engine 122 (operation S3410). In addition, in order to classify the content of the screen, the full screen is resized to 224×224, and input to the genre classifying engine S3400 (operation S3420).

The screen adjuster 130 may collect the output values of the image quality classifying engine and the genre classifying engine (operation S3500) to adjust the image setting of the screen in the screen adjuster 130 (operation S3600). In an embodiment of the present disclosure, the screen adjuster 130 may set to operate once per second, and determine the image quality and the screen content genre based on the recognized result of the last five seconds based on the time window. For example, when the image quality result value has been [low, low, medium, medium, medium] in the image quality classifying engine, the image quality may be determined as ‘medium’. In an embodiment, the image quality may be classified into the low (144p, 240p), the medium (360p), and the high (480p, 720p, 1080p) for each resolution. According to an embodiment of the present disclosure, the screen adjuster 130 may automatically scale up or scale down the resolution through deep learning techniques for increasing the resolution based on the resolution of the quality classifying engine. In addition, the screen adjuster 130 may control the values related to sharpness, noise, contrast, etc. by setting the Display-IC value based on the resolution of the image quality classifying engine.

The screen adjuster 130 may adjust the screen according to a predetermined setting such as a sports mode, a movie mode, a document reading mode (reader mode), a game mode, and a photo mode according to the genre classification.

After adjusting the screen, the screen adjuster 130 may set to operate once again per second, and return to operation S3100 in order to infer the image quality of the screen or the genre of the screen content and start the screen adjusting process.

The embodiments of the present disclosure described above may be implemented through computer programs executable through various components on a computer, and such computer programs may be recorded in computer-readable media. For example, the recording media may include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present application (especially in the appended claims), the terms “a/an” and “the” include both singular and plural references, unless the context clearly conditions otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the example embodiments described above or by the use of such terms unless limited by the appended claims. Therefore, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof.

Therefore, technical ideas of the present disclosure are not limited to the above-mentioned embodiments, and it is intended that not only the appended claims, but also all changes equivalent to claims, should be considered to fall within the scope of the present disclosure.

What is claimed is:

1. A method for adjusting a screen by inferring the image quality of the screen or the content of the screen on a display, comprising:
collecting data related a full screen generated by resizing the full screen or cropping a portion of the full screen on the display;
applying the collected data to a learned AI model for classifying the image quality of the full screen, the genre of the content of the full screen, or whether the full screen is a text/an image;
outputting the image quality of the full screen, the genre of the content of the full screen, or whether the full screen is a text/an image classified from the learned AI model; and
adjusting the screen of the display based on the image quality of the full screen, the genre of the content of the full size, or whether the full screen is a text/an image, which have been output.

2. The method for adjusting the screen by inferring the image quality of the screen or the content of the screen on the display of claim 1,
wherein the learned AI model is an image quality classifying engine learned to infer the image quality of the full screen by using images having cropped a specific portion having the maximum edge of the full screen and specific resolution results labeled to the cropped images as learning data.

3. The method for adjusting the screen by inferring the image quality of the screen or the content of the screen on the display of claim 1,
wherein the learned AI model is a genre classifying engine learned to infer the genre of the content of the full screen by using images having resized the full screen to a specific size and genre classified results having labeled the resized images by genre of the content of the screen as learning data.

4. The method for adjusting the screen by inferring the image quality of the screen or the content of the screen on the display of claim 1,
wherein the learned AI model is a text/image classifying engine learned to infer whether the full screen is a text/an image by using area images having cropped the full screen into a plurality of areas and text/image results having labeled the area images with a text or an image as learning data.

5. The method for adjusting the screen by inferring the image quality of the screen or the content of the screen on the display of claim 4,
wherein the text/image classifying engine is learned to classify the area images, which have been generated by cropping the full screen into the plurality of areas in proportion to a resolution, into a text or an image through a Convolution Neural Network (CNN).

6. The method for adjusting the screen by inferring the image quality of the screen or the content of the screen on the display of claim 5,
wherein the text/image classifying engine classifies the area images into four classes of an image, an image prefer, a text prefer, and a text through the Convolution Neural Network (CNN), and determines whether the full screen is a text/an image according to whether a final value summed by multiplying the four classes for the area images by a weight is positive or negative.

7. The method for adjusting the screen by inferring the image quality of the screen or the content of the screen on the display of claim 4,
wherein the adjusting the screen of the display turns on a reader mode for changing a color temperature to be suitable for reading a document when the full screen is a text screen, and turns off the reader mode when the full screen is an image screen or a partial area of the full screen is not a text screen.

8. The method for adjusting the screen by inferring the image quality of the screen or the content of the screen on the display of claim 2,
wherein the image quality classifying engine is learned by confirming a specific portion having the maximum edge from the cropped images and utilizing a Data Augmentation method.

9. The method for adjusting the screen by inferring the image quality of the screen or the content of the screen on the display of claim 2,
wherein the image quality classifying engine is learned by scaling-up the cropped images to Full High Definition (FHD) by using Bilinear Interpolation, and labeling the image quality of the cropped images as high, medium, low based on the characteristics in which the edge density increase at higher resolution.

10. The method for adjusting the screen by inferring the image quality of the screen or the content of the screen on the display of claim 2,
wherein the outputting the image quality of the full screen, the genre of the content of the full screen, or whether the full screen is a text/an image comprises classifying the image quality of the full screen into high, medium, low according to a resolution through the image quality classifying engine.

11. The method for adjusting the screen by inferring the image quality of the screen or the content of the screen on the display of claim 1,
wherein the adjusting the screen of the display is executed by collecting results having repeated the collecting the data related to the full screen, the applying to the learned AI model, and the outputting the image quality of the full screen, the genre of the content of the full screen, or whether the full screen is a text/an image at a specific time interval.

12. A computer readable recording medium storing a program programmed to adjust a screen by inferring the image quality of the screen or the content of the screen on a display, the program having computer-executable instructions for performing steps comprising:
collecting data related to a full screen generated by resizing the full screen or cropping a portion of the full screen on the display;
applying the collected data to a learned AI model for classifying the image quality of the full screen, the genre of the content of the full screen, or whether the full screen is a text/an image;
outputting the image quality of the full screen, the genre of the content of the full screen, or whether the full screen is a text/an image classified from the learned AI model; and
adjusting the screen of the display based on the image quality of the full screen, the genre of the content of the full screen, or whether the full screen is a text/an image, which has been output.

13. A screen adjusting controller for adjusting a screen through inference of the image quality of the screen or the content of the screen on the display, comprising:
a data collector for collecting data related to a full screen generated by resizing the full screen or cropping a portion of the full screen on the display;
a screen classifier for applying the collected data to a learned AI model for classifying the image quality or the genre of the full screen, or whether the full screen is a text/an image; and
a screen adjuster for adjusting the screen of the display based on the image quality of the full screen, the genre of the content of the full screen, or whether the full screen is a text/an image, which have been classified.

14. The screen adjusting controller for adjusting the screen on the display of claim 13,
wherein the learned AI model comprises at least one engine among
an image quality classifying engine learned to infer the image quality of the full screen by using images having cropped a specific portion having the maximum edge of the full screen and specific resolution results labeled to the cropped images as learning data;
a genre classifying engine learned to infer the genre of the content of the full screen by using image having resized the full screen to a specific size and genre classified results having labeled the resized images by genre of the content of the screen as the learning data; and
a text/image classifying engine learned to infer whether the full screen is a text/an image by using area images having cropped the full screen into a plurality of areas and text/image results having labeled the area images with a text or an image as the learning data.

15. The screen adjusting controller for adjusting the screen on the display of claim 14,
wherein the text/image classifying engine is learned to classify the area images generated by cropping the full screen into the plurality of areas in proportion to a resolution into a text or an image through a CNN.

16. The screen adjusting controller for adjusting the screen on the display of claim 14,
wherein the screen adjuster turns on a reader mode for changing a color temperature to be suitable for reading a document when the full screen is classified as a text screen, and turns off the reader mode when the full screen has been classified as an image screen or a partial area among the full screen is not a text screen.

17. The screen adjusting controller for adjusting the screen on the display of claim 14,
wherein the image quality classifying engine is learned to scale up the cropped images to FHD by using Bilinear Interpolation, and label the image quality of the cropped images with high, medium, low based on the characteristics in which the edge density increases at higher resolution.

18. The screen adjusting controller for adjusting the screen on the display of claim 13,
wherein the screen adjuster adjusts the screen of the display by collecting the data related to the full screen at a specific interval from the data collector and the screen classifier and collecting the classified results of the image quality of the full screen, the genre of the content of the full screen, or whether the full screen is a text/an image, which has been classified from the screen classifier.

19. The screen adjusting controller for adjusting the screen on the display of claim 13,
wherein the screen adjuster adjusts one or more among backlight adjustment, stereoscopic, sharpness, edge sharpness, image noise removal, brightness, contrast, gamma, overdrive, color temperature, color depth, resolution, and color by a predetermined setting for the image quality of the full screen, the genre of the content of the full screen, or whether the full screen is a text/an image, which has been classified.

20. A screen adjusting system for adjusting a screen through inference of the image quality of the screen or the content of the screen on the display, the screen adjusting system comprising a screen adjusting controller for adjusting the screen and a server,
wherein the screen adjusting controller comprises
a data collector for collecting data related to a full screen generated by resizing the full screen or cropping a portion of the full screen on the display;
a screen classifier for applying the collected data to a learned AI model for classifying the image quality or the genre of the full screen, or whether the full screen is a text/an image;
a screen adjuster for adjusting the screen of the display based on the image quality of the full screen, the genre of the content of the full screen, or whether the full screen is a text/an image, which have been classified; and
a communicator for communicating with the server, the communicator transmitting the image quality of the full screen or the content of the screen on the display collected from the data collector to the server,
wherein the server comprises an AI model learner for generating a learned AI model having learned the image quality of the full screen or the content of the screen, which has been received through a deep neural network,
wherein the server is configured to transmit the learned AI model having learned through the AI model learner to the screen adjusting controller, and
wherein the screen classifier of the screen adjusting controller is configured to classify the image quality of the full screen, the genre of the content of the full screen, or whether the full screen is a text or an image on the display through the learned AI model received from the server.
